(19) United States
(12) Patent Application Publication
(10) Pub. No.: US 2020/0120864 A1
(43) Pub. Date: Apr. 23, 2020

(54) SNAP LOADER SYSTEM AND MATCHING FLEXIBLE LINE BLADE

(71) Applicant: Aero-Flex Technologies, Inc., Rock Hill, SC (US)

(72) Inventor: Vincent D. Morabit, Rock Hill, SC (US)

(21) Appl. No.: 16/658,394

(22) Filed: Oct. 21, 2019

Related U.S. Application Data
(60) Provisional application No. 62/747,882, filed on Oct. 19, 2018.

(51) Int. Cl. A01D 34/416

(52) U.S. Cl. CPC A01D 34/4166; A01D 2101/00; A01D 34/4168

(57) ABSTRACT

A line loader system for a rotating trimmer head includes a channel defined in the rotating trimmer head and having an entry slot, a curved track, and an outlet slot, a locking cleat formed in the rotating trimmer head adjacent the outlet slot, and a flexible line blade positionable and snap-lockable in the channel in a use position. The flexible line blade has a spade at a leading end and a neck adjacent the spade, where a width of the neck is narrower than a width of the locking cleat such that as the spade is positioned through the outlet slot past the locking cleat, the neck engages the locking cleat. With the described system, no mechanical devices are needed to secure the line blades, and no tools are required for installation or removal.

### CROSS-REFERENCES TO RELATED APPLICATIONS

This application claims the benefit of U.S. Provisional Patent Application No. 62/747,882, filed Oct. 19, 2018, the entire content of which is herein incorporated by reference.

### STATEMENT REGARDING FEDERALLY SPONSORED RESEARCH OR DEVELOPMENT

(NOT APPLICABLE)

### BACKGROUND

The invention relates to rotating trimmer heads and, more particularly, to a flexible line blade loader system and corresponding flexible line blade that can be quickly and conveniently secured and released without having to separate the head and without the use of tools.

Existing monofilament line and flexible line blade loading systems enable flexible line blades to be loaded in a horizontal or radial plane through an outlet cavity and through a channel to have a spade lock into a receiver fork. With existing systems, however, it is difficult to remove the lines/blades. The existing systems typically load lines/blades in one direction (generally radial direction), and the lines/blades are pulled from the opposite direction in the same horizontal plane for removal. Additionally, the channel length can serve to reduce the affected tensile load on the vulnerable spade neck, resulting in a weaker connection at the spade neck and therefore greater vulnerability to higher tensile failures.

### SUMMARY

The system of the described embodiments incorporates the deflection at a preformed leading spade at the insertion end of a line blade that upon entry and through a preformed channel is forced to deflect and then to snap into a fixed fork receiver or cleat. A tighter curvature radius will reduces tensile forces on the spade neck as well as the added ‘snap’ force to assist engagement into the cleat. The functionality is accomplished within the convenient reach of a user's thumb to deflect the spade and pull to remove the blade.

The system utilizes a vertical (axial) loading system that more effectively resolves limitations of the existing systems. The finger reach to release the locked blade is more ergonomic and convenient. Additionally, the looping path is smaller while the direction of release is more naturally done with one hand/thumb, within comfortable reach of the thumb to avoid the need to dislodge the spade with one hand and to pull a line out with the other.

A protective recessed pocket has less exposure to the risk of being dislodged by outside objects while the trimmer head rotates. The channel also has a higher radius track length that avoids reducing the effective tensile load on the spade neck.

In an exemplary embodiment, a line loader system for a rotating trimmer head includes a channel defined in the rotating trimmer head and having an entry slot, a curved track, and an outlet slot, a locking cleat formed in the rotating trimmer head adjacent the outlet slot, and a flexible line blade positionable and snap-lockable in the channel in a use position. The flexible line blade has a spade at a leading end and a neck adjacent the spade, where a width of the neck is narrower than a width of the locking cleat such that as the spade is positioned through the outlet slot past the locking cleat, the neck engages the locking cleat.

The system may further include an insert guide positioned in the channel and that is positioned adjacent the curved track and includes an insert guide stop. The flexible line blade may include a line blade stop spaced from the spade that is configured to engage the insert guide stop when the flexible blade is in the use position. The flexible line blade may further include a flange adjacent the neck and a hinge adjacent the flange, where the spade, the neck and the flange may be wider than they are tall such that the spade, the neck and the flange have a horizontal orientation, and where the hinge may be taller than it is wide such that the hinge has a vertical orientation substantially perpendicular to the spade, the neck and the flange. The entry slot may be inverse T-shaped. The line blade stop may be continuous with the hinge, where the spade, the neck and the flange are configured for insertion through a horizontal leg of the T-shaped entry slot, and where the line blade stop may be configured for insertion though a vertical leg of the T-shaped entry slot.

The insert guide may include a tension wall forming part of the curved track.

The flexible line blade may further include a flange adjacent the neck, a hinge adjacent the flange, and a cutting blade adjacent the hinge. The spade, the neck and the flange may be wider than they are tall such that the spade, the neck and the flange have a horizontal orientation, and the hinge may be taller than it is wide such that the hinge has a vertical orientation substantially perpendicular to the spade, the neck and the flange. Additionally, the cutting blade may be wider than it is tall such that the cutting blade has a horizontal orientation substantially perpendicular to the hinge. In some embodiments, the spade, the neck, the flange, the hinge and the cutting blade are formed in a single mold.

The system may include a plurality of the channels (e.g., four channels) in the rotating trimmer head, a corresponding plurality of the locking cleats, and a corresponding plurality of the flexible line blades.

A curvature radius of the curved track may be less than 1″.

In another exemplary embodiment, a method of securing or removing a flexible line blade to or from a rotating trimmer head includes the steps of (a) inserting a flexible line blade into the entry slot, the flexible line blade including a spade at a leading end and a neck adjacent the spade, wherein a width of the neck is narrower than a width of the locking cleat; (b) displacing the spade through the curved track and past the locking cleat; and (c) engaging the neck with the locking cleat.

Step (b) may be practiced by displacing the spade through the curved track until the neck snaps into the locking cleat. An insert guide may be positioned in the channel adjacent the curved track and may include an insert guide stop, where step (b) may be practiced by displacing the spade through the curved track until the flexible line blade engages the insert guide stop. The flexible line blade may include a line blade stop spaced from the spade, where step (b) may be practiced by displacing the spade through the curved track until the line blade stop of the flexible line blade engages the insert guide stop.

Removing the flexible line blade may include displacing the spade until the neck is disengaged from the locking cleat, and at the same time pulling the flexible line blade out of the rotating trimmer head through the curved track. The removing step may be practiced with one hand.

### BRIEF DESCRIPTION OF THE DRAWINGS

These and other aspects and advantages will be described in detail with reference to the accompanying drawings, in which:

FIG. 1 shows an exemplary rotating trimmer head for the line loader system of the described embodiments;

FIG. 2 shows a flexible line blade of the line loader system;

FIG. 3 shows the line loader system with several line blades installed in the rotating trimmer head;

FIG. 4 is a side view of the line loader system;

FIG. 5 is a sectional view showing one of the channels and insert guides in the rotating trimmer head;

FIGS. 6-8 illustrate a process for installing and removing a flexible line blade;

FIG. 9 is a sectional view showing details of a blade stop and tension wall of the insert guide;

FIG. 10 is a detailed view of the insert guide;

FIG. 11 is a sectional perspective view of the line loader system;

FIG. 12 shows the insert guide in the form of a full 360° molded ring as a single or multi-part component.

### DETAILED DESCRIPTION

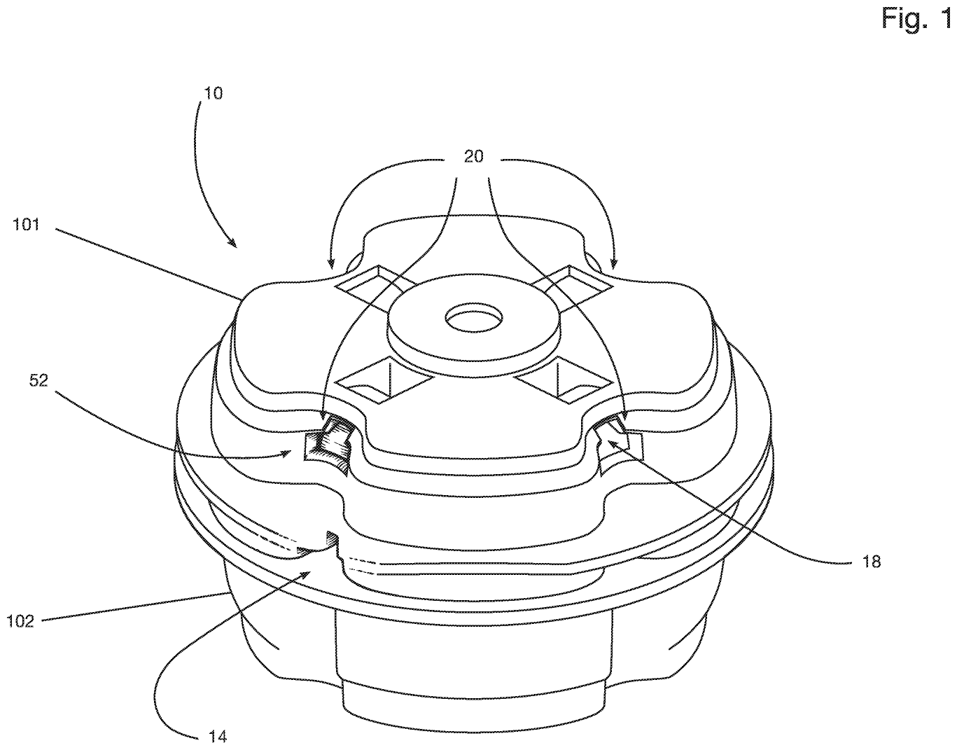

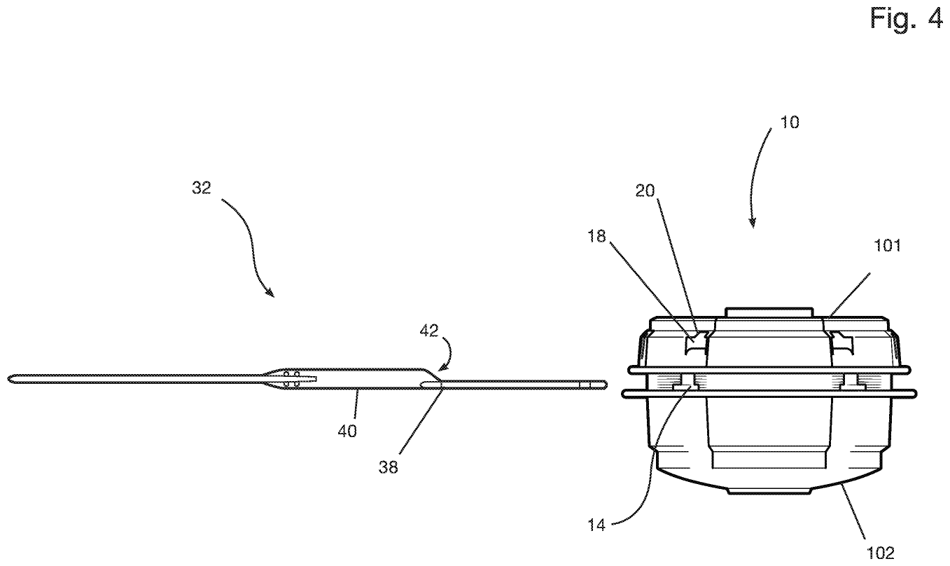

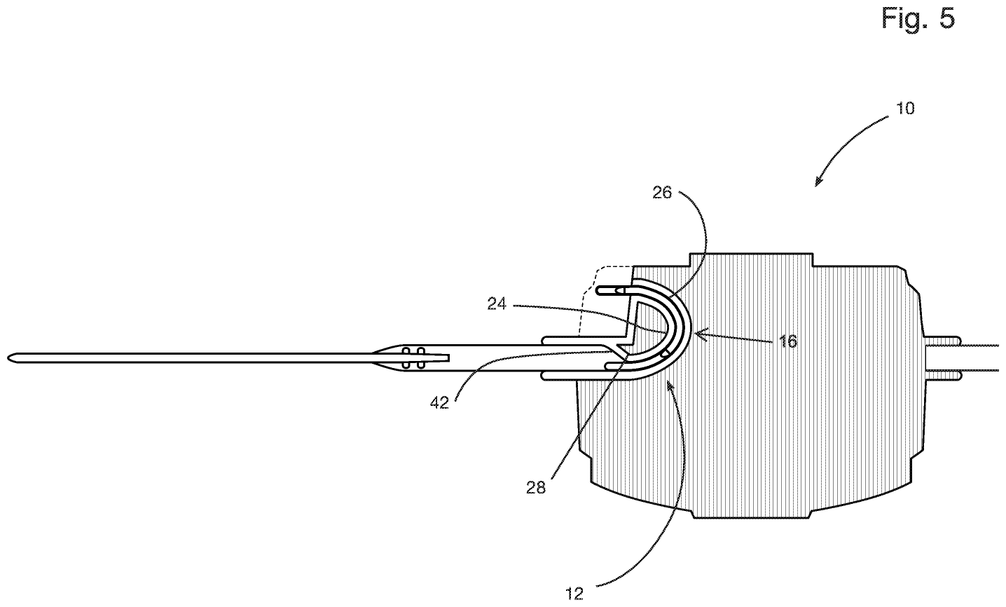

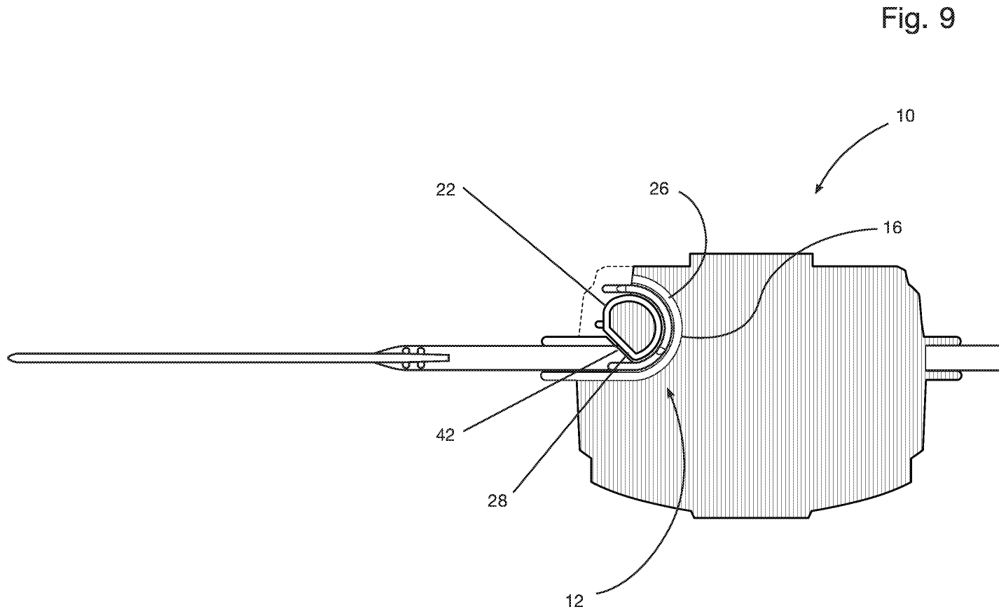

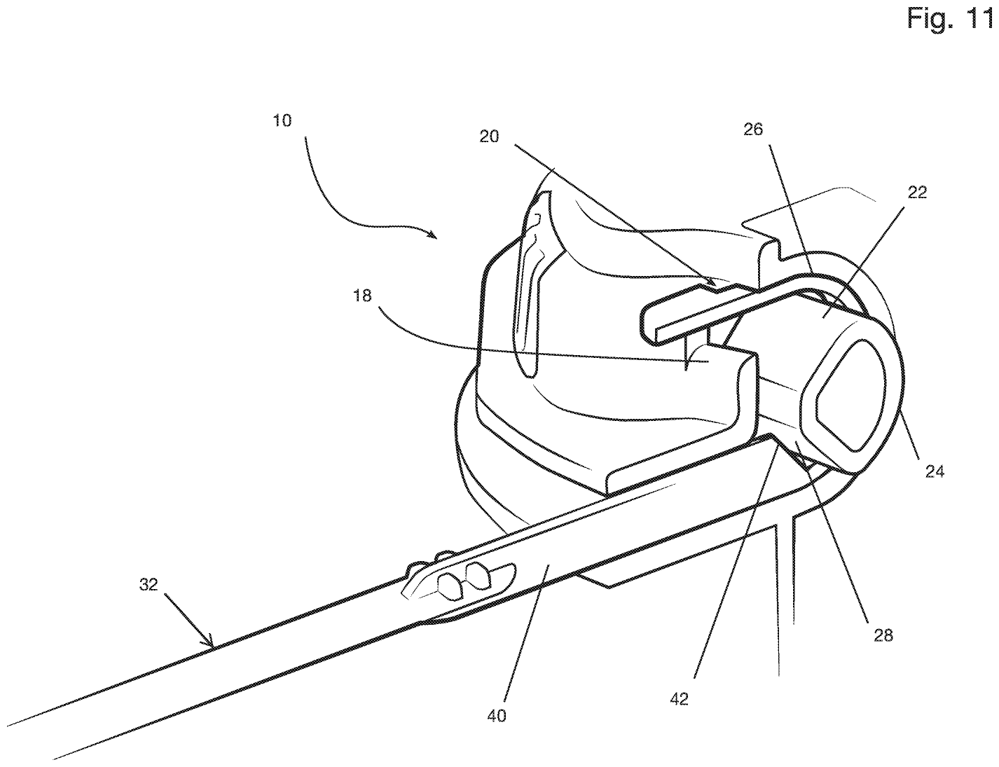

FIG. 1 shows an exemplary rotating trimmer head 10 of the line loader system according to the described embodiments. The exemplary rotating trimmer head 10 includes an upper receiver 101 securable to an arbor or the like (not shown) for rotation by a motor and a lower cap 102 coupled with the upper receiver 101. FIG. 4 is a side view of the system and FIGS. 5, 9 and 11 are sectional views. The rotating trimmer head 10 includes a plurality of channels 12, each of which have an entry slot 14, a curved wall 16 and an outlet slot 18. A locking cleat 20 is formed in the rotating trimmer head 10 adjacent each of the outlet slots 18. In some embodiments, the channels 12 extend generally vertically as shown, although a horizontal channel could be used.

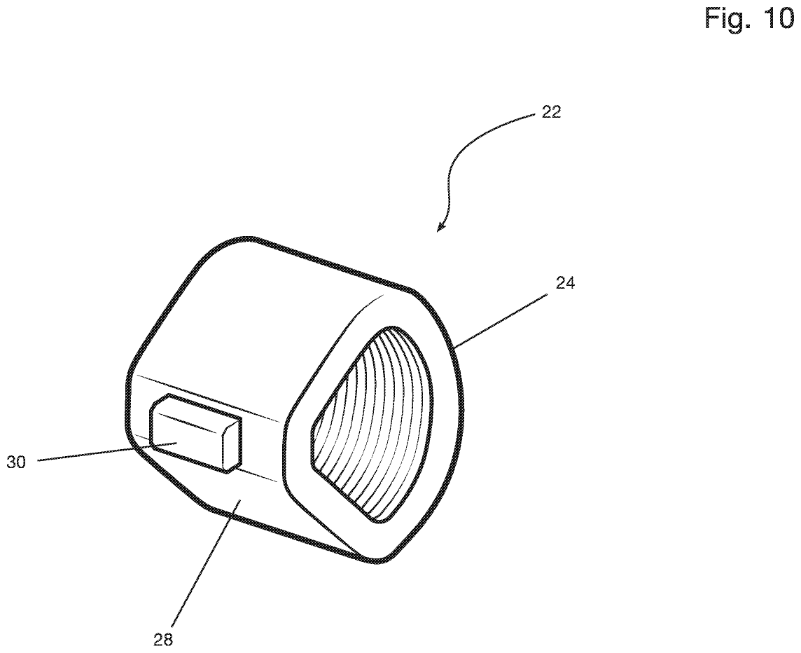

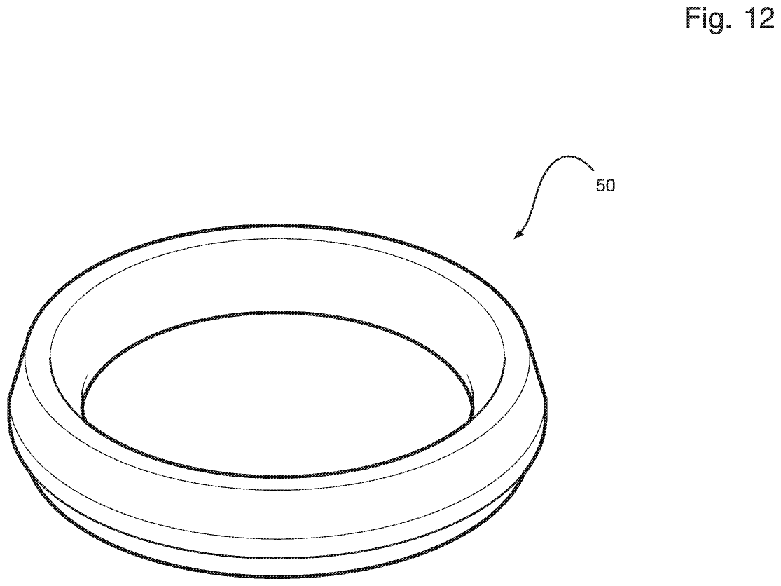

An insert guide 22 may be positioned/secured in the channel 12 adjacent the curved wall 16. The insert guide 22 is shown in FIGS. 5, 9 and 10. The insert guide 22 includes a tension wall 24 disposed facing the curved wall 16 of the channel 12. The tension wall 24 and the curved wall 16 define a curved or channeled track 26. In some embodiments, a curvature radius of the channeled track 26 may be less than 1″. The insert guide 22 is provided with an insert guide stop 28 that is cooperable with a corresponding stop on the flexible line blades (discussed in more detail below). The insert guide 22 also includes an insert locator 30 that serves to secure and position the insert guide 22 in the channel 12. For example, the insert locator 30 may engage a corresponding notch or the like in the trimmer head 10. The insert guide 22 can be a single guide at each line blade outlet slot 18 or a full 360° molded ring as a single or multi-part component inserted into the rotating trimmer head 10 as a permanent fixture. An exemplary 360° ring 50 is shown in FIG. 12.

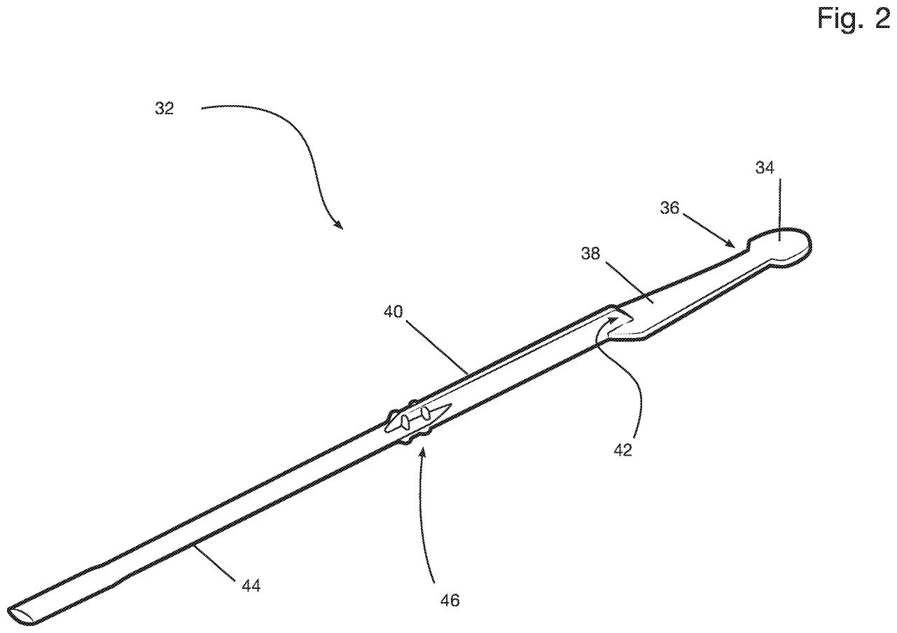

A flexible line blade 32 forming part of the line loader system is shown in FIG. 2. The flexible line blade 32 includes a spade 34 at a leading end and a neck 36 adjacent the spade 34. As shown, a width of the neck 36 is narrower than a width of the spade 34. The blade 32 also includes a flange 38 adjacent the neck 36 and a hinge 40 adjacent the flange 38. A line blade stop 42 is positioned at an intersection of the flange 38 and the hinge 40. A cutting blade 44 is adjacent the hinge 40, and a transition section 46 is interposed between the hinge 40 and the blade 44. In some embodiments, the spade 34, the neck 36, the flange 38, the hinge 40 and blade stop 42, the transition section 46 and the cutting blade 44 are formed in a single mold. The spade 34, the neck 36 and the flange 38 may be wider than they are tall such that the spade 34, the neck 36 and the flange 38 have a horizontal orientation. The hinge 40 including the blade stop 42 is generally taller than it is wide such that the hinge 40 has a vertical orientation substantially perpendicular to the spade 34, the neck 36 and the flange 38. The cutting blade 44 may similarly have a horizontal orientation but may also be slightly angled to create an updraft or the like to help lift vegetation during cutting.

As shown in FIGS. 5, 9 and 11, the line blade stop 42 is spaced from the spade 34 and engages the insert guide stop 28 of the insert guide 22 when the flexible blade 32 is inserted into a use position.

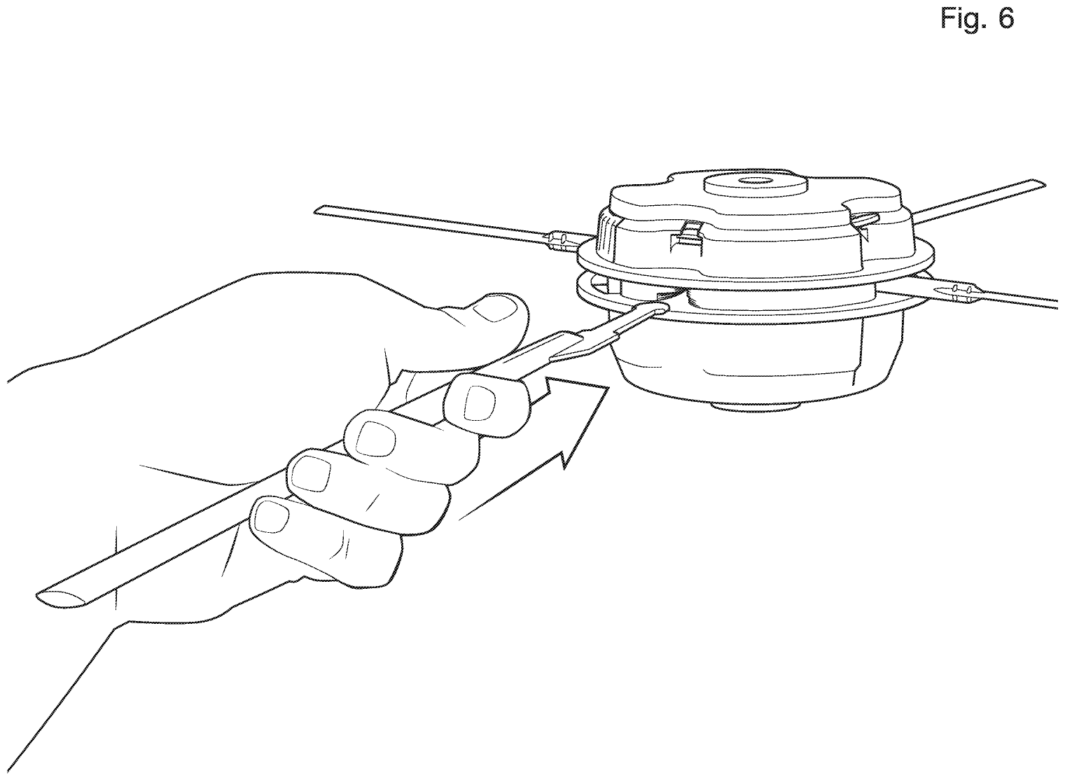

FIGS. 6-8 show the process for securing and removing the flexible line blade 32 to or from the rotating trimmer head 10. As shown in FIG. 1, for example, the entry slot 14 may be inverse T-shaped. In this context, the spade 34, the neck 36 and the flange 38 are configured for insertion through a horizontal leg of the T-shaped entry slot 14, and the line blade stop 42 and hinge 40 are configured for insertion through the vertical leg of the T-shaped entry slot 14. In this manner, the flexible line blade 32 can be inserted in only one orientation.

The flexible line blade 32 is inserted into the entry slot 14 such that the spade 34 is displaced through the channeled track 26 and past the locking cleat 20. Because the width of the neck 36 is narrower than a width of the locking cleat 20, as the spade 34 is positioned through the outlet slot 18 past the locking cleat 20, the neck 36 engages the locking cleat 20. The flexible line blade 32 is naturally biased to a generally flat or straight orientation, and as the spade 34 and flange 38 are curved in the channeled track 26 during insertion, the spade 34, neck 36 and flange are bent against the natural bias. As such, when the spade 34 passes the locking cleat 20, the neck 36 snaps into the locking cleat 20. In this position, the line blade stop 42 engages the insert guide stop 28.

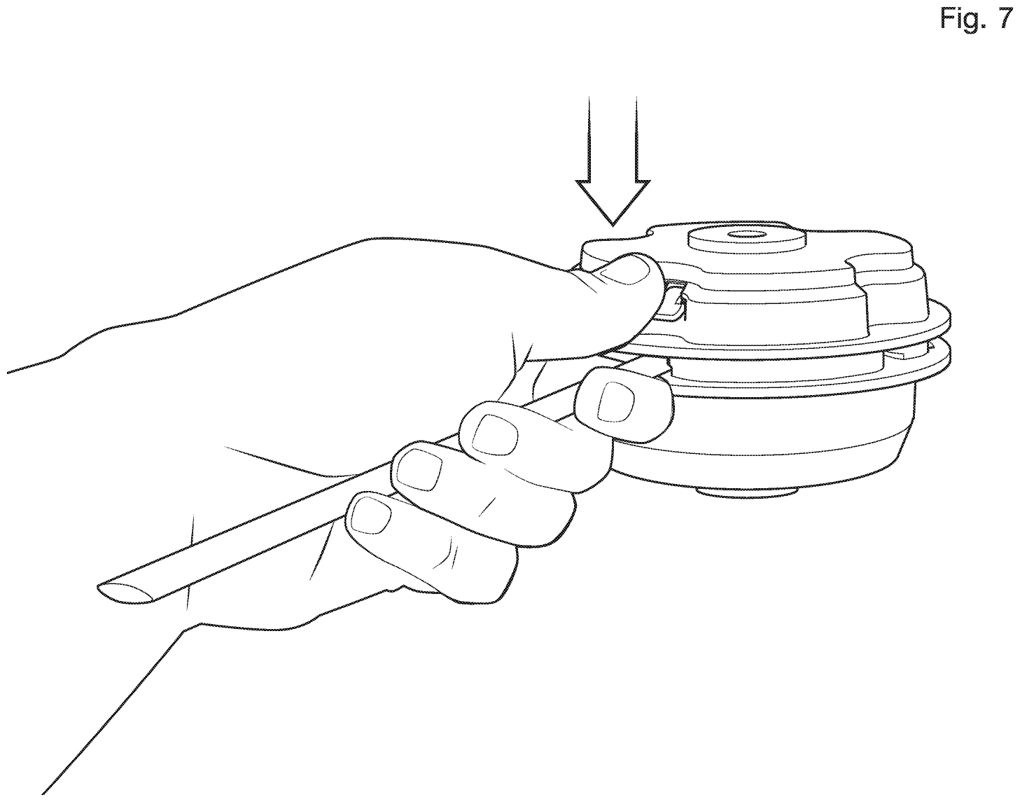

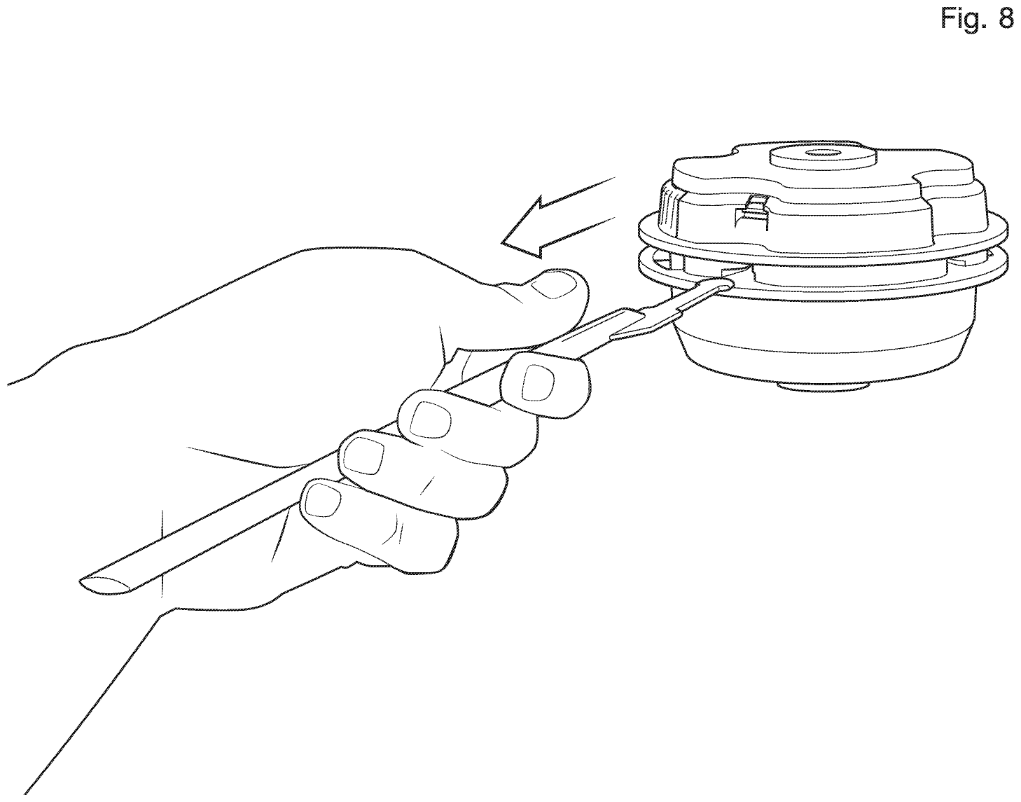

With reference to FIGS. 7 and 8, in order to remove the flexible line blades 32, the spade 34 is displaced downward until the neck 36 is disengaged from the locking cleat 20. At the same time, the flexible line blade 32 is pulled out of the rotating trimmer head 10 through the same channeled track 26 in which the blade 32 was inserted. As shown in FIGS. 7 and 8, the removal process can be performed with one hand.

The insert guide tension wall 24 serves to maintain cutting swath dimensions from pull-out forces, to reduce inner connector stress from heavily concentrated forces applied to the flange 38 area of the blades 32, and to serve a part of the channeled track 26 for the installation path. The tension wall 24 may absorb up to 50% of the tensile forces on the line when trimming vegetation, therefore reducing the tensile and shear force on the smaller neck 36 when the spade 34 is engaged into the cleat 20. Absorbing Durometer of the insert guide can play a part by reducing the rate of impact loading to reduce stress at the neck 36. The insert guide 22 serves as part of the channeled track 26 that guides the spade 34 along the circular but generally vertical track and guides the neck 36 into the locking cleat 20.

With the line loader system of the described embodiments, no mechanical devices are needed to hold the line blades in place while installing line blades, removing line blades, or trimming. No tools are needed for installation or removal. The line blade entry slot enables installation in only one orientation that ensures the correct line blade orientation. The line blade stop limits entry up to the insert guide stop after assuring proper seating of the spade into the cleat. Chamfering at leading edges of the spade tip may be provided to reduce or minimize restrictions of entering progress along the channeled track. Internal line blade guide channels assure that the flexible line blade stays within the channeled track path through stages along the loading path. Upper channeled wall guides may be provided to assist guidance and alignment for directing the spade into the outlet slot and for guiding the neck into the locked position within the cleat.

Removal of the line blades is facilitated with ergonomic downward (or axial) thumb actuation with consistent and convenient direction of release of the spade from the cleat engagement when removing line blades. A negative angled spade at the interface with the cleat keeps the spade in the “on” position, to provide self-engaging interfering angles and even seating that benefits with a more uniform spreading of tensile forces transmitted through the narrow blade neck. The angle differences create an added friction to oppose movement when engaged. The cleat may have a spade matching/negative 3+ degree angle difference to help with the self-locking feature to assure that the line blade stays in place during cutting. An angled spade surface contact creates a different seating angle surface between the spade and the cleat and also serves to assist with self-locking or interfering angles against the head outlet slot when the spade is engaged within the cleat. The angle differences create an added friction to oppose a release movement when engaged to assure the line blades stay in place.

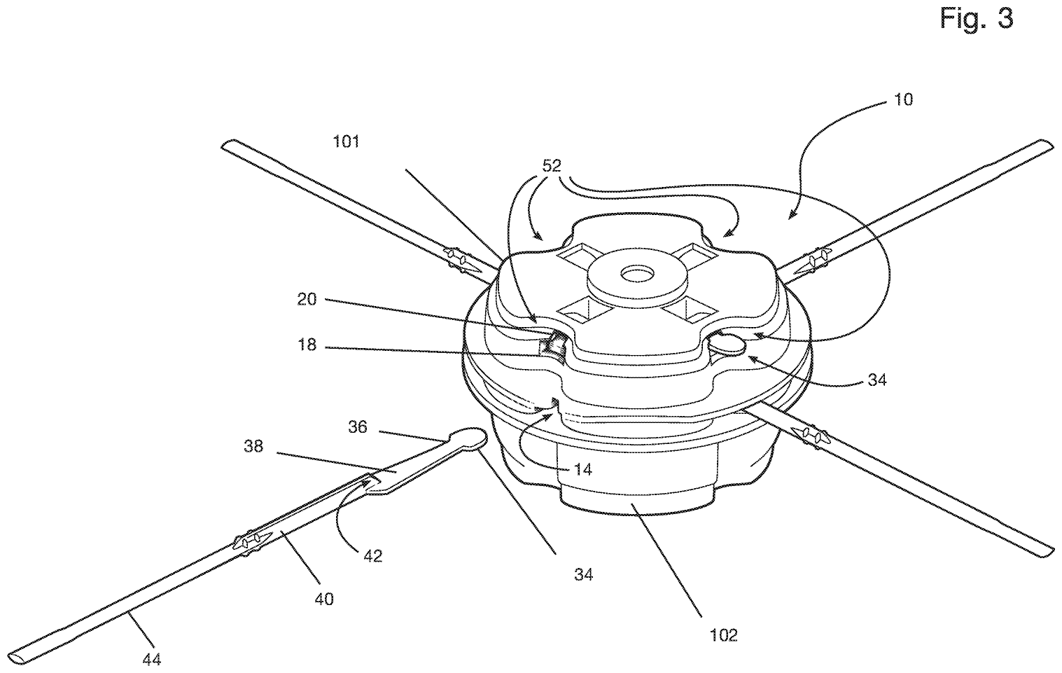

In some embodiments, the line blade spades may be held in place via the neck while the free extended spade end is positioned within protective/shielded pockets 52 (see e.g., FIGS. 1 and 3) throughout the vertical plane of the exposed spade protruding to the outside beyond the outer slot of an assembled line blade. The protected pocket or cove 52 is molded as part of the rotating trimmer head (directly above the line blade entry slot). The protected pocket shields the exposed spade from disengagement forces of vegetation or solid objects while the rotating head is exposed to such objects. The full vertical (up to down, axial) pockets protect the extended spade by shielding them from disengagement or shearing horizontal forces that are normal to the direction of spade release, therefore reducing the potential or outside objects from forcing the spade to release from the cleat. Any impact or contact forces from outside objects will not be in the disengaging direction of the spade.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. A line loader system for a rotating trimmer head, the line loader system comprising:
a channel defined in the rotating trimmer head, the channel including an entry slot, a curved track, and an outlet slot;
a locking cleat formed in the rotating trimmer head adjacent the outlet slot; and
a flexible line blade positionable and snap-lockable in the channel in a use position, the flexible line blade including a spade at a leading end and a neck adjacent the spade, wherein a width of the neck is narrower than a width of the locking cleat such that as the spade is positioned through the outlet slot past the locking cleat, the neck engages the locking cleat.

2. A line loader system according to claim 1, further comprising an insert guide positioned in the channel, the insert guide being positioned adjacent the curved track and including an insert guide stop.

3. A line loader system according to claim 2, wherein the flexible line blade comprises a line blade stop spaced from the spade, the line blade stop being configured to engage the insert guide stop when the flexible blade is in the use position.

4. A line loader system according to claim 3, the flexible line blade further comprising a flange adjacent the neck and a hinge adjacent the flange, wherein the spade, the neck and the flange are wider than they are tall such that the spade, the neck and the flange have a horizontal orientation, and wherein the hinge is taller than it is wide such that the hinge has a vertical orientation substantially perpendicular to the spade, the neck and the flange.

5. A line loader system according to claim 4, wherein the entry slot is inverse T-shaped.

6. A line loader system according to claim 5, wherein the line blade stop is continuous with the hinge, wherein the spade, the neck and the flange are configured for insertion through a horizontal leg of the T-shaped entry slot, and wherein the line blade stop is configured for insertion though a vertical leg of the T-shaped entry slot.

7. A line loader system according to claim 2, wherein the insert guide comprises a tension wall forming part of the curved track.

8. A line loader system according to claim 1, the flexible line blade further comprising a flange adjacent the neck, a hinge adjacent the flange, and a cutting blade adjacent the hinge.

9. A line loader system according to claim 8, wherein the spade, the neck and the flange are wider than they are tall such that the spade, the neck and the flange have a horizontal orientation, wherein the hinge is taller than it is wide such that the hinge has a vertical orientation substantially perpendicular to the spade, the neck and the flange, and wherein the cutting blade is wider than it is tall such that the cutting blade has a horizontal orientation substantially perpendicular to the hinge.

10. A line loader system according to claim 9, wherein the spade, the neck, the flange, the hinge and the cutting blade are formed in a single mold.

11. A line loader system according to claim 1, comprising a plurality of the channels in the rotating trimmer head, a corresponding plurality of the locking cleats, and a corresponding plurality of the flexible line blades.

12. A line loader system according to claim 1, wherein a curvature radius of the curved track is less than 1″.

13. A method of securing or removing a flexible line blade to or from a rotating trimmer head, wherein a channel is defined in the rotating trimmer head and includes an entry slot, a curved track, and an outlet slot, and wherein a locking cleat is formed in the rotating trimmer head adjacent the outlet slot, the method comprising:
(a) inserting a flexible line blade into the entry slot, the flexible line blade including a spade at a leading end and a neck adjacent the spade, wherein a width of the neck is narrower than a width of the locking cleat;
(b) displacing the spade through the curved track and past the locking cleat; and
(c) engaging the neck with the locking cleat.

14. A method according to claim 13, wherein step (b) is practiced by displacing the spade through the curved track until the neck snaps into the locking cleat.

15. A method according to claim 13, wherein an insert guide is positioned in the channel adjacent the curved track and includes an insert guide stop, and wherein step (b) is practiced by displacing the spade through the curved track until the flexible line blade engages the insert guide stop.

16. A method according to claim 15, wherein the flexible line blade comprises a line blade stop spaced from the spade, and wherein step (b) is practiced by displacing the spade through the curved track until the line blade stop of the flexible line blade engages the insert guide stop.

17. A method according to claim 13, wherein removing the flexible line blade comprises displacing the spade until the neck is disengaged from the locking cleat, and at the same time pulling the flexible line blade out of the rotating trimmer head through the curved track.

18. A method according to claim 17, wherein the removing step is practiced with one hand.

19. A line loader system for a rotating trimmer head, the line loader system comprising:
a channel defined in the rotating trimmer head, the channel including an entry slot, a curved wall, and an outlet slot, wherein the outlet slot faces an exterior of the rotating trimmer head and is spaced from the entry slot;
an insert guide positioned in the channel, the insert guide including a tension wall facing the curved wall and defining a curved track with the curved wall;
a locking cleat formed in the rotating trimmer head adjacent the outlet slot; and
a flexible line blade positionable and snap-lockable in the channel in a use position, the flexible line blade including a spade at a leading end and a neck adjacent the spade, wherein a width of the neck is narrower than a width of the locking cleat such that as the spade is positioned through the outlet slot past the locking cleat, the neck engages the locking cleat.

20. A line loader system according to claim 19, wherein the insert guide comprises an insert guide stop, and wherein the flexible line blade comprises a line blade stop spaced from the spade, the line blade stop being configured to engage the insert guide stop when the flexible blade is in the use position.
